(19) United States
(12) Patent Application Publication
(10) Pub. No.: US 2026/0148993 A1
(43) Pub. Date: May 28, 2026

(54) ADDITIVE FOR LITHIUM SULFUR BATTERY

(71) Applicant: The Johns Hopkins University, Baltimore, MD (US)

(72) Inventor: Nicholas G. Pavlopoulos, Columbia, MD (US)

(21) Appl. No.: 19/342,012

(22) Filed: Sep. 26, 2025

Related U.S. Application Data
(60) Provisional application No. 63/725,019, filed on Nov. 26, 2024.
(60) Provisional application No. 63/817,044, filed on Jun. 3, 2025.

(51) Int. Cl. H01M 4/62; H01M 4/02; H01M 4/04; H01M 4/139; H01M 4/38; H01M 10/052

(52) U.S. Cl. CPC H01M 4/628; H01M 4/0404; H01M 4/139; H01M 4/38; H01M 4/622; H01M 4/625; H01M 10/052; H01M 2004/028

(57) ABSTRACT

An additive for a lithium sulfur cell includes monomers polymerized into a polymer, at least some of the monomers being functionalized with at least one tertiary amine group. The polymer enables activation of elemental sulfur and prevents shuttling of polysulfides within the lithium sulfur cell. An electrode, lithium sulfur cell, and methods for manufacturing the additive and a cathode are also disclosed.

### CROSS-REFERENCE TO RELATED APPLICATIONS

The present application claims benefit under 35 U.S.C. § 119(e) to U.S. Provisional Patent Application No. 63/725,019 filed on Nov. 26, 2024, and U.S. Provisional Patent Application No. 63/817,044 filed on Jun. 3, 2025, which are hereby incorporated by reference in their entirety.

### FIELD

This disclosure relates generally to lithium sulfur batteries, for example to a polymer additive for lithium sulfur batteries that contains one or more tertiary amine groups, to electrodes and cells including such an additive, and/or to methods for manufacturing an additive and an electrode.

### BACKGROUND

Lithium sulfur batteries are among the most promising future battery technologies for high energy density applications. This is because lithium sulfur batteries are capable of theoretical energy densities up to eight times that of leading lithium ion chemistries. In addition, the use of sulfur as a cathode active material instead of cobalt and nickel, which are often used in lithium ion and lithium metal cell chemistries, circumvents supply chain security concerns.

Nonetheless, lithium sulfur chemistry presents unique challenges. For example, during discharge of a lithium sulfur battery, sulfur in the cathode may undergo multiple discreet electrochemical reactions as it transforms from an initial Li₂S₈ composition, exhibiting cyclic rings of eight sulfur atoms, to produce Li₂S₆ and Li₂S₄ species and eventually arriving at Li₂S₂ or Li₂S species when the battery is fully discharged. Li₂S₆ and Li₂S₄ species are often referred to as “higher order polysulfides,” and the conversion of these species may make up nearly ⅓ of the discharge potential of a lithium sulfur cell. However, effectively converting such higher order polysulfides requires that they remain in contact with the cathode to be converted into Li₂S₂ or Li₂S. This is difficult because these higher order polysulfides are soluble in organic electrolytes commonly used in lithium sulfur cells. Due to this solubility, the higher order lithium polysulfides are able to drift away from the cathode, potentially even through the separator to arrive at and foul the lithium metal anode. This “polysulfide shuttling effect” can drastically reduce the cell capacity, cycle life, energy density, and battery life of a lithium sulfur battery.

In addition, not all elemental sulfur that is present in a cell may be utilized during charging and discharging of the lithium sulfur cell. In many cases, low sulfur utilization may be the result of poor steric accessibility to available elemental sulfur or because available sulfur may be unable to be in close contact with the cathode to react under the applied voltage. Low sulfur utilization can also reduce the cell capacity and energy density of a lithium sulfur battery.

### SUMMARY

In view of the above, it is desirable to develop lithium sulfur cells that minimize or prevent the polysulfide shuttling effect and that enable or boost activation of elemental sulfur, to thereby increase the electrical characteristics of the resulting lithium sulfur battery. Such lithium sulfur cells may be achieved by incorporating an additive according to aspects into one or more of an electrode, an electrolyte, and/or a separator used in the lithium sulfur cell.

In some aspects, an additive for a lithium sulfur cell may comprise monomers polymerized into a polymer, with at least some of the monomers being functionalized with at least one tertiary amine group. The polymer may enable the activation of elemental sulfur and prevent the shuttling of polysulfides within the lithium sulfur cell.

In some aspects, an electrode for a lithium sulfur cell may comprise elemental sulfur, conductive carbon, a binder, and an additive. The additive may comprise monomers polymerized into a polymer, with at least some of the monomers being functionalized with a tertiary amine group. The polymer may enable the activation of elemental sulfur and prevent the shuttling of polysulfides within the lithium sulfur cell.

In some aspects, a lithium sulfur cell may comprise a cathode, an anode, a separator, an electrolyte, and an additive. The cathode may comprise elemental sulfur, conductive carbon, and a binder. The anode may comprise lithium metal. The electrolyte may transport lithium ions through the separator and between the cathode and the anode. The additive may comprise monomers polymerized into a polymer, with at least some of the monomers being functionalized with a tertiary amine group. The polymer may enable the activation of elemental sulfur and prevent the shuttling of polysulfides within the lithium sulfur cell.

In some aspects, a method for manufacturing an additive for a lithium sulfur cell may comprise functionalizing acrylate ester monomers with a tertiary amine group to form acrylate based monomers, mixing the acrylate based monomers with acrylate ester monomers, and polymerizing the acrylate based monomers and acrylate ester monomers in the presence of a radical initiator to form a copolymer.

In some aspects, a method for manufacturing an electrode for a lithium sulfur cell may comprise mixing elemental sulfur, conductive carbon, a binder, and an additive to form a slurry, coating the slurry onto a foil, and drying the slurry to form the electrode. The additive may comprise a polymer formed by polymerizing a mixture of acrylate ester monomers and acrylate based monomers. The acrylate based monomers may comprise acrylate ester monomers functionalized with a tertiary amine group.

### BRIEF DESCRIPTION OF THE DRAWINGS/FIGURES

The accompanying drawings, which are incorporated herein and form part of the specification, illustrate the present disclosure and, together with the description, further serve to explain the principles of the present disclosure and to enable those skilled in the relevant art(s) to make and use aspects described herein.

FIG. 1 shows structural diagrams of acrylate ester monomers functionalized with a tertiary amine group, according to some aspects.

FIG. 2 shows a flowchart for a method for manufacturing an additive for a lithium sulfur cell, according to some aspects.

FIG. 3 shows a schematic diagram of a lithium sulfur cell, according to some aspects.

FIG. 4 shows a flowchart for a method for manufacturing an electrode for a lithium sulfur cell, according to some aspects.

FIG. 5 shows measurement data of the voltage of a lithium sulfur cell according to some aspects as a function of the specific capacity of the cell for several cycle numbers of the lithium sulfur cell.

FIG. 6 shows measurement data of the specific capacity of a lithium sulfur cell according to some aspects as a function of cycle number.

FIG. 7A shows measurement data of the specific capacity of a lithium sulfur cell according to some aspects as a function of cycle number.

FIG. 7B shows measurement data of the voltage of a lithium sulfur cell according to some aspects as a function of the specific capacity of the cell for several cycle numbers of the lithium sulfur cell.

The features of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements. Additionally, generally, the left-most digit(s) of a reference number identifies the drawing in which the reference number first appears. Unless otherwise indicated, the drawings provided throughout the disclosure should not be interpreted as to-scale drawings.

### DETAILED DESCRIPTION

The aspects described herein, and references in the specification to “one aspect,” “an aspect,” “an exemplary aspect,” “an example aspect,” etc., indicate that the aspects described can include a particular feature, structure, or characteristic, but every aspect may not necessarily include the particular feature, structure, or characteristic. Moreover, such phrases are not necessarily referring to the same aspect. Further, when a particular feature, structure, or characteristic is described in connection with an aspect, it is understood that it is within the knowledge of those skilled in the art to effect such feature, structure, or characteristic in connection with other aspects whether or not explicitly described.

Spatially relative terms, such as “beneath,” “below,” “lower,” “above,” “on,” “upper” and the like, can be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus can be otherwise oriented (rotated 90 degrees or at other orientations) and the spatially relative descriptors used herein can likewise be interpreted accordingly.

The terms “about,” “approximately,” “nearly,” or the like can be used herein indicates the value of a given quantity that can vary based on a particular technology. Based on the particular technology, the terms “about,” “approximately,” “nearly,” or the like can indicate a value of a given quantity that varies within, for example, 1-30% of the value (e.g., ±1%, ±5%, ±10%, ±20%, or ±30% of the value).

### Additives for Lithium Sulfur Cells

Described herein are additives for use in lithium sulfur cells according to some aspects. Within aspects, such additives may be incorporated in one or more of an electrode, an electrolyte, and/or a separator in a lithium sulfur cell. Additives according to aspects may enable activation of elemental sulfur and prevent shuttling of polysulfides within the resulting lithium sulfur cell.

An additive for a lithium sulfur cell according to some aspects may comprise monomers polymerized into a polymer. According to aspects, prior to polymerization, at least some of the monomers may be functionalized with tertiary amine groups. The use of tertiary amine groups may, in some aspects, avoid adverse electrochemical reactions with the hydrogens present in primary and secondary amines. In some aspects, non-amine bearing monomers may be functionalized with amines. In some aspects, amine-bearing monomers may be functionalized with asymmetric alkyl groups. In some aspects, amine-bearing monomers may be functionalized with other beneficial side chain groups, such as, for example, quaternary functionalization to form an ammonium salt.

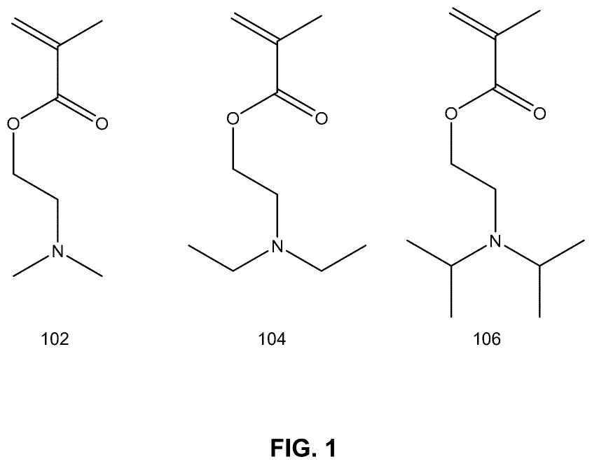

According to some aspects, the monomers may comprise acrylate ester monomers. Some of the acrylate ester monomers may be functionalized to include one or more tertiary amine groups, thereby forming acrylate-based monomers. In aspects, the acrylate based monomers may have a general form of N-alkyl(1)-N-alkyl(2) amino-alkyl(3) alkyl(4) acrylate. For example, the acrylate based monomers may a form of di-alkyl(1)-amino-alkyl(2) alkyl(3) alkyl(4) acrylate. As non-limiting examples, the acrylate based monomers may be one or more of dimethylaminoethylmethacrylate (DMAEMA), diethylaminoethylmethacrylate (DEAEMA), diisopropylaminoisopropylmethacrylate (DIPAEMA), or a combination thereof. FIG. 1 shows chemical structural diagrams of several acrylate based monomers, according to some aspects. For example, structure 102 is of DMAEMA, structure 104 is of DEAEMA, and structure 106 is of DIPAEMA, according to aspects. Within aspects, each acrylate based monomer may comprise a methacrylate monomer that has been functionalized at one end with a tertiary amine group. For example, an ethyl methacrylate monomer may be functionalized with a dimethylamine group to form DMAEMA, as shown in structure 102. Somewhat similarly, an ethyl methacrylate monomer may be functionalized with a diethylamine group to form DEAEMA, as shown in structure 104. Within aspects, isopropyl methacrylate may be functionalized with a diisopropyl amine group to form DIPAEMA, as shown in structure 106. Aspects are not limited to these configurations, and other methacrylates and tertiary amine functional groups may be used. In some aspects, any configuration of base monomers and amine functional groups may be used that results in a functionalized monomer satisfying the general form of N-alkyl(1)-N-alkyl(2) amino-alkyl(3) alkyl(4) acrylate.

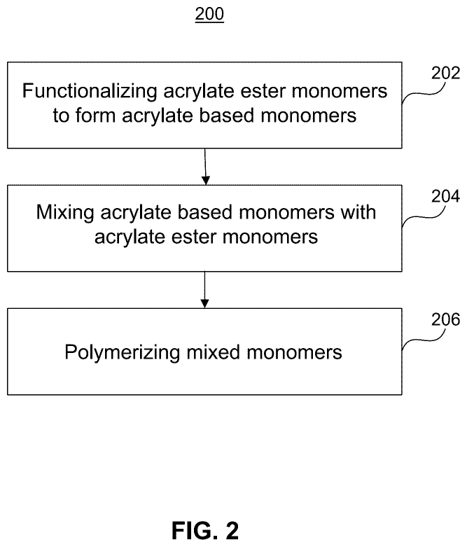

FIG. 2 shows a flowchart for a method 200 of manufacturing the additive, according to some aspects. Within aspects, method 200 may begin with operation 202 of functionalizing acrylate ester monomers to form acrylate based monomers. In some aspects, operation 202 may be performed by functionalizing any base monomer with amine functional groups to realize a functionalized monomer that satisfies the general form of N-alkyl(1)-N-alkyl(2) amino-alkyl(3) alkyl(4) acrylate, as discussed above.

According to aspects, method 200 may then proceed to operation 204, in which the acrylate based monomers produced in operation 202 are mixed with additional acrylate ester monomers. Within aspects, the acrylate based monomers and acrylate ester monomers may be mixed in a molar ratio of between 1:99 and 99:1. In some aspects, the acrylate based monomers and acrylate ester monomers may be mixed in a molar ratio of about 1:1.

Within aspects, at operation 206, the mixed acrylate based monomers and acrylate ester monomers may be polymerized to form a copolymer. In some aspects, the polymerization be a random radical polymerization process. According to some aspects, the polymerization may be done in the presence of a radical initiator, for example, an azo compound such as azobisisobutyronitrile (AlBN) or an organic peroxide such as benzoyl peroxide. In some aspects, the polymerization process may be a controlled or uncontrolled radical polymerization, and may optionally include one or more chain transfer agents (CTAs).

The resulting copolymer may, in some aspects, include copolymers, random copolymers, and/or block copolymers of amine-bearing acrylates as well as non-amine bearing acrylates and non-acrylate comonomers. According to some aspects, the resulting copolymer may include two or more different methacrylate segments. As one example, the resulting copolymer may include a methylmethacrylate segment and a dialkylaminoethylmethacrylate segment. However, aspects are not limited to this example, and the resulting copolymer may include various methacrylate segments. The resulting copolymer may be used as an additive for a lithium sulfur cell, as described below.

Without limiting the aspects described herein, the amine functional groups are believed to aid in sequestering soluble polysulfides that form in the 2.6-2.0 V potential window during discharge of the lithium sulfur cell. The additive is believed to enable the rapid conversion of soluble polysulfides into insoluble polysulfide species, thereby preventing the shuttling of polysulfides away from the cathode. In addition, in some aspects, the formation of dialkylaminoethylmethacrylate or similar segments in the copolymer is believed to enable activation of elemental sulfur by electron donation from the amine groups to the sulfur.

### Lithium Sulfur Cells Including the Additive

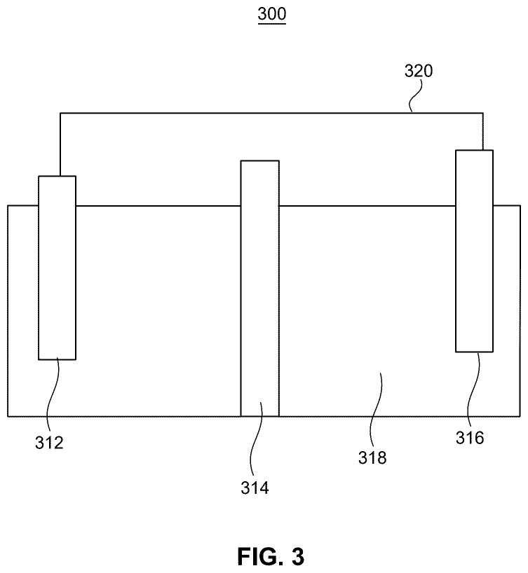

FIG. 3 shows a schematic diagram of a lithium sulfur cell 300, according to some aspects. Within aspects, lithium sulfur cell 300 may include a cathode 312, an anode 316 electrically connected to a cathode 312 (e.g., by wire 320), an electrolyte 318 provided in the cell, and a separator 314 disposed between cathode 312 and anode 316. The additive according to aspects may be incorporated into one more of these components of lithium sulfur cell 300.

In some aspects, the additive may be incorporated into cathode 312 of lithium sulfur cell 300. Within aspects, cathode 312 may include elemental sulfur, conductive carbon, a binder, and the additive. In aspects, the conductive carbon may be electrically conductive carbon to increase the electrical conductivity of cathode 312. As non-limiting examples, the conductive carbon may be one or more of graphite, carbon nanotubes, and carbon black. In aspects, the binder may be a polymer binder to increase adhesion between the elemental sulfur and the conductive carbon. As non-limiting examples, the binder includes one or more of polyethylene (PE), polyacrylic acid (PAA), lithiated polyacrylic acid (LiPAA), and polyvinylidinefluoride (PVDF).

According to aspects, the additive may be combined with an acrylate based polymer to increase its incorporation into cathode 312. As a non-limiting example, the additive may be combined with a polymer such as polymethylmethacrylate (PMMA) before being incorporated into the cathode.

Within aspects, the additive may constitute less than or equal to about 25% of the cathode by weight. In some aspects, the additive may constitute less than or equal to about 10% of the cathode by weight. In some aspects, the additive may constitute greater than or equal to about 1% and less than or equal to about 10% of the cathode by weight.

According to aspects, the presence of the additive in the electrode may enable activation of elemental sulfur by activating sulfur in the cathode through Lewis base interactions. That is, in some aspects, the additive may act as an electron donor to bond with and activate elemental lithium in the cathode.

According to aspects, the presence of the additive in the electrode may prevent shuttling of polysulfides within lithium sulfur cell 300. In some aspects, the additive may prevent shuttling of polysulfides by binding higher order polysulfides to cathode 312 during discharge of lithium sulfur cell 300.

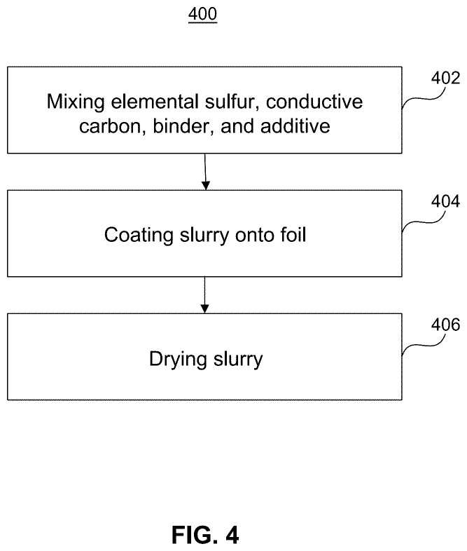

FIG. 4 shows a flowchart for a method 400 of manufacturing an electrode for a lithium sulfur cell, according to aspects. Within aspects, method 400 may begin with operation 402 of mixing elemental sulfur, conductive carbon, a binder, and the additive to form a slurry. At operation 404, the slurry formed in operation 402 may be coated onto a foil. Within aspects, the foil may be, for example, aluminum. According to aspects, at operation 406, the slurry may be dried to form a composite electrode.

Returning to FIG. 3, in some aspects, the additive may be incorporated into electrolyte 318 of lithium sulfur cell 300. In some aspects, electrolyte 318 may be a liquid electrolyte such as, for example, a lithium salt dissolved in an organic solvent. In some aspects, the organic solvent may be one or more of a cyclic ether, a short-chain ether, and a glycol ether. As non-limiting examples, the organic solvent may include one or more of dioxolane, dimethoxy ethane, bis(2-methyoxyethyl) ether (“diglyme”), and tetraethylene glycol dimethyl ether. As non-limiting examples, the lithium salt may include one or more of lithium bis(trifluoromethanesulfonyl)imide (LiTFSI), lithium bis(fluorosulfonyl)imide (LiFSI), lithium hexafluorophosphate (LiPF₆), lithium nitrate (LiNO₃), and lithium difluoro(oxalato)borate (LiDFOB), or a combination thereof. In some aspects, a concentration of the lithium salt may be greater than or equal to 0.1 molar and less than or equal to 2 molar. Within aspects, the additive may be dissolved along with the lithium salt in the organic solvent. In some aspects, electrolyte 318 may be a solid electrolyte or a composite solid electrolyte. The additive may be incorporated into such a solid electrolyte or composite solid electrolyte during the preparation of the solid or composite solid electrolyte.

According to aspects, the presence of the additive in electrolyte 318 may hamper the mobility of polysulfides through electrolyte 318, thereby preventing the shuttling of polysulfides from the cathode through the electrolyte and to the anode during discharge of lithium sulfur cell 300.

In some aspects, the additive may be incorporated into separator 314 of lithium sulfur cell 300. Within aspects, separator 314 may be a solid polymer separator, such as polypropylene (PP) or polyethylene (PE). In some aspects, separator 314 may be a composite formed of one or more layers of PP and one or more layers of PE. In some aspects, separator 314 may comprise one or more coatings to increase the efficacy of the separator and to limit, to some extent, the shuttling of polysulfides. According to aspects, the additive may be incorporated into one or more layers of separator 314. As a non-limiting example, the additive may be incorporated into the PP and or PE during preparation of separator 314. As another non-limiting example, the additive may be applied as a coating to the surface of separator 314.

According to aspects, the presence of the additive in separator 314 may prevent the shuttling of polysulfides through separator 314 and from cathode 312 to anode 316 during discharge of lithium sulfur cell 300.

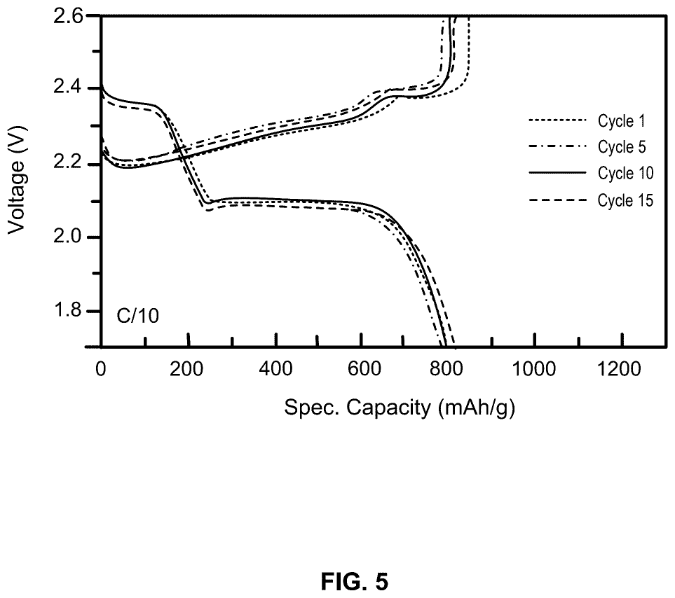

FIG. 5 shows voltage and capacity measurement data for an exemplary lithium sulfur cell according to aspects. In one aspect, the X-axis shows specific capacity (in mAh/g) and the Y-axis shows voltage (in volts). In one aspect, a lithium sulfur cell was constructed according to aspects herein with DEAEMA incorporated as the additive into the cathode of the cell at 5% by weight of the cathode. Within aspects, the cell was charged and discharged at a rate of C/10, thus taking 10 hours to fully charge and discharge the cell. Data is shown for the first, fifth, tenth, and fifteenth cycles. The data shows very little change over the course of fifteen cycles, consistently achieving a capacity of about 800 mAh/g.

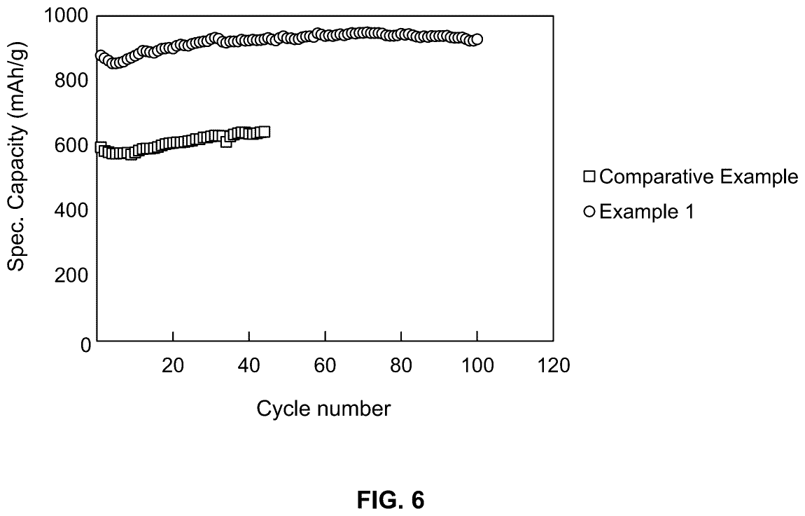

FIG. 6 plots a discharge capacity data for a number of cycles (e.g., at least 20 cycles) of an exemplary lithium sulfur cell including the additive and for a comparative example without the additive according to some aspects. In one aspect, the X-axis shows cycle number and the Y-axis shows specific capacity (in mAh/g). The data in FIG. 6 shows remarkable stability in the specific capacity of the lithium sulfur cell. The comparative example lithium sulfur cell without the additive exhibited a much lower specific capacity of approximately 600 mAh/g. It is believed that with further optimization according to the aspects herein, the capacity of a lithium sulfur cell with the additive may approach the theoretical limit of 1675 mAh/g.

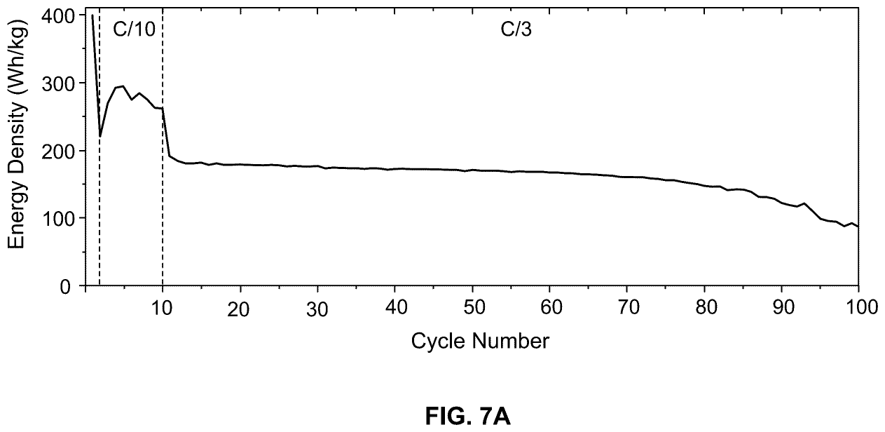

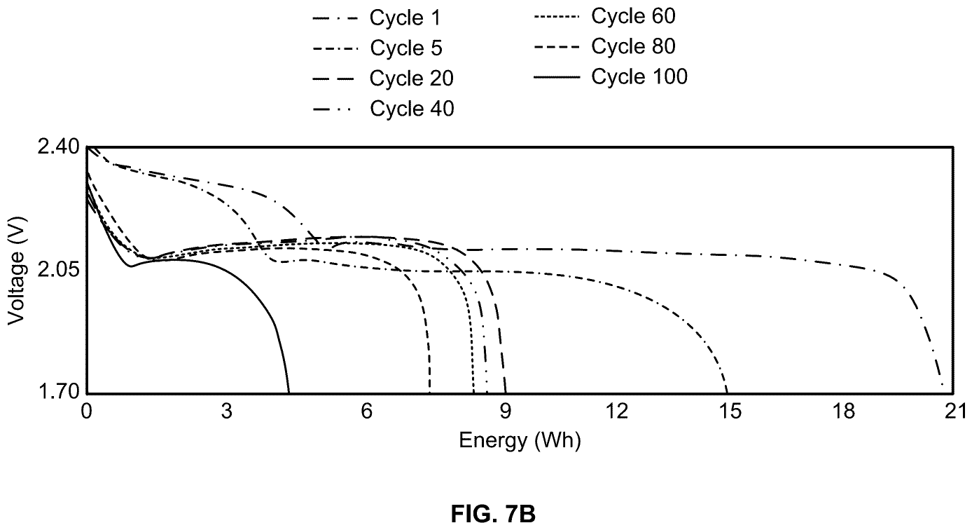

FIG. 7A plots energy density data for up to one hundred cycles of an exemplary lithium sulfur cell including the additive according to some aspects. In one aspect, a lithium sulfur cell was constructed according to aspects herein with DEAEMA incorporated as the additive into the cathode of the cell at 5% by weight of the cathode. The data shown is representative of a lithium sulfur cell according to aspects containing 6500 mg of sulfur for a demonstrated 20 Watt hours of energy stored. In one aspect, the X-axis shows cycle number and the Y-axis shows gravimetric energy density (in Wh/kg). Vertical dashed lines indicate different charge/discharge regimes, starting at C/100 for cycle number 1, C/10 for cycle number 2-10, and C/3 for cycle numbers 11-100. The data in FIG. 7A shows that a lithium sulfur cell according to aspects may achieve an energy density far higher than that of a conventional sulfur cell, for example, up to 400 Wh/kg at a C/100 charge/discharge rate, up to 300 Wh/kg at a C/10 charge/discharge rate, and up to 200 Wh/kg at a C/3 charge/discharge rate.

FIG. 7B plots voltage and energy measurement data for the exemplary lithium sulfur cell of FIG. 7A. In one aspect, the X-axis shows energy (in Wh) and the Y-axis shows voltage (in volts). Data is shown for cycle numbers one, five, twenty, forty, sixty, eighty, and one hundred. Cycle 1 corresponds to a C/100 discharge rate, cycle 5 to a C/10 discharge rate, and all subsequent cycles to a C/3 discharge rate. The data demonstrates energy storage capacity over 20 Wh at low discharge rate, retaining 10 Wh at even at higher discharge rates. The data also demonstrates little change in the energy or voltage at high discharge rates, with little change in the energy or voltage over the course of at least sixty cycles, with only minor changes up to eighty cycles, and still high performance even at 100 cycles.

The foregoing description of specific aspects will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary aspects, but should be defined only in accordance with the following claims and their equivalents.

What is claimed is:

1. An additive for a lithium sulfur cell comprising:
monomers polymerized into a polymer, at least some of the monomers being functionalized with at least one tertiary amine group,
wherein the polymer is configured to enable activation of elemental sulfur and prevent shuttling of polysulfides within the lithium sulfur cell.

2. The additive of claim 1, wherein, prior to polymerization, the monomers comprise:
acrylate ester monomers; and
acrylate based monomers comprising the at least one tertiary amine group.

3. The additive of claim 2, wherein:
the acrylate based monomers comprise the general form N-alkyl(1)-N-alkyl(2) amino-alkyl(3) alkyl(4) acrylate.

4. The additive of claim 3, wherein:
the acrylate based monomers comprise dimethylaminoethylmethacrylate (DMAEMA), diethylaminoethylmethacrylate (DEAEMA), diisopropylaminoisopropylmethacrylate (DIPAEMA), or a combination thereof.

5. The additive of claim 2, wherein:
the acrylate based monomers and the acrylate ester monomers are provided in a molar ratio of between 1:99 and 99:1.

6. The additive of claim 5, wherein:
the acrylate based monomers and the acrylate ester monomers are provided in a molar ratio of approximately 1:1.

7. An electrode for a lithium sulfur cell comprising:
elemental sulfur;
conductive carbon;
a binder; and
an additive comprising:
monomers polymerized into a polymer, at least some of the monomers being functionalized with a tertiary amine group,
wherein the polymer is configured to enable activation of elemental sulfur and prevent shuttling of polysulfides within the lithium sulfur cell.

8. The electrode of claim 7, wherein:
the additive is combined with an acrylate based polymer.

9. The electrode of claim 8, wherein:
the acrylate based polymer comprises polymethylmethacrylate (PMMA).

10. The electrode of claim 7, wherein:
the additive constitutes less than or equal to about 50% of the electrode by weight.

11. The electrode of claim 10, wherein:
the additive constitutes less than or equal to about 10% of the electrode by weight.

12. The electrode of claim 11, wherein:
the additive constitutes greater than or equal to about 1% and less than or equal to about 5% of the electrode by weight.

13. A lithium sulfur cell comprising:
a cathode comprising elemental sulfur, conductive carbon, and a binder;
an anode comprising lithium metal;
a separator;
an electrolyte configured to transport lithium ions through the separator and between the cathode and the anode; and
an additive comprising:
monomers polymerized into a polymer, at least some of the monomers being functionalized with a tertiary amine group,
wherein the polymer is configured to enable activation of elemental sulfur and prevent shuttling of polysulfides within the lithium sulfur cell.

14. The lithium sulfur cell of claim 13, wherein:
the additive is incorporated into the cathode and configured to:
activate sulfur in the cathode through Lewis base interactions, and
bind polysulfides to the cathode during discharge of the lithium sulfur cell.

15. The lithium sulfur cell of claim 13, wherein:
the additive is incorporated into the electrolyte and configured to prevent the shuttling of polysulfides through the electrolyte during discharge of the lithium sulfur cell.

16. The lithium sulfur cell of claim 13, wherein:
the additive is incorporated into the separator and configured to prevent the shuttling of polysulfides through the separator during discharge of the lithium sulfur cell.

17. The lithium sulfur cell of claim 13, wherein:
the lithium sulfur cell demonstrates a specific capacity greater than about 600 mAh/g.

18. The lithium sulfur cell of claim 17, wherein:
the lithium sulfur cell maintains the specific capacity greater than about 600 mAh/g for at least 20 cycles.

19. A method for manufacturing an additive for a lithium sulfur cell, the method comprising:
functionalizing acrylate ester monomers with a tertiary amine group to form acrylate based monomers;
mixing the acrylate based monomers with acrylate ester monomers; and
polymerizing the acrylate based monomers and acrylate ester monomers in the presence of a radical initiator to form a copolymer.

20. A method for manufacturing an electrode for a lithium sulfur cell, the method comprising:
mixing elemental sulfur, conductive carbon, a binder, and an additive to form a slurry;
coating the slurry onto a foil; and
drying the slurry to form the electrode,
wherein the additive comprises a polymer formed by polymerizing a mixture of acrylate ester monomers and acrylate based monomers, and
wherein the acrylate based monomers comprise acrylate ester monomers functionalized with a tertiary amine group.
